(19) United States
(12) Patent Application Publication
(10) Pub. No.: US 2026/0178668 A1
(43) Pub. Date: Jun. 25, 2026

(54) SEARCH CONTROL SYSTEM, SEARCH CONTROL METHOD, AND INFORMATION STORAGE MEDIUM

(71) Applicant: Rakuten Group, Inc., Tokyo (JP)

(72) Inventors: Yilin LI, Singapore (SG); Fan XU, Singapore (SG); Tingxi WU, Singapore (SG); Guangda LI, Singapore (SG); Ting CAI, Tokyo (JP)

(21) Appl. No.: 19/263,515

(22) Filed: Jul. 9, 2025

(30) Foreign Application Priority Data
Dec. 24, 2024 (JP) 2024-228018

(51) Int. Cl. G06F 16/9032; G06F 16/9038; G06Q 30/0601

(52) U.S. Cl. CPC G06F 16/90332; G06F 16/9038; G06Q 30/0625

(57) ABSTRACT

A prompt generation module generates, based on a chat message received from a terminal, a prompt to be output to a language model. A prompt output module outputs the prompt to the language model. A display control module outputs, to the terminal, a chat message based on an answer from the language model to the prompt. A first search intermediation module generates a search query based on a log related to exchange of a chat message with the terminal. The first search intermediation module outputs the search query to a first search system. The display control module outputs, to the terminal, a search result received from the first search system in response to the output of the search query to the first search system.

### CROSS-REFERENCE TO RELATED APPLICATIONS

The present application claims priority from Japanese application JP 2024-228018 filed on Dec. 24, 2024, the content of which is hereby incorporated by reference into this application.

### BACKGROUND OF THE INVENTION

### 1. Field of the Invention

The present invention relates to a search control system, a search control method, and an information storage medium.

### 2. Description of the Related Art

In Japanese Patent Application Laid-open No. 2011-133926, there is described a technology which supports a product search executed by a user in a shopping site on the Internet.

Moreover, in recent years, a technology which makes use of a large language model (LLM) has been attracting attention. As an example of this technology, in Japanese Patent Translation Publication No. 2024-521053, there is described a technology which uses a large language model in generating an automated assistant response.

### SUMMARY OF THE INVENTION

The user repeats output of a prompt to a language model such as the LLM and reception of an answer from this language model, to thereby be able to acquire information in such a sense that as if the user were naturally chatting a person.

However, in order to execute a certain search based on the information acquired via the chat which uses the language model, it is required for the user to separately input a search query to a search system, which is troublesome.

The present invention has been made in view of the above-mentioned problem, and has an object to provide a search control system, a search control method, and an information storage medium which enable a user to seamlessly acquire a search result obtained by a search system in such a sense that the user is naturally chatting a human.

A search control system according to at least one embodiment of the present invention includes: prompt generation means for generating, based on a chat message received from a terminal, a prompt to be output to a language model; prompt output means for outputting the prompt to the language model; chat message output means for outputting, to the terminal, a chat message based on an answer from the language model in response to the prompt; search query generation means for generating a search query based on a log related to exchange of a chat message with the terminal; search query output means for outputting the search query to a search system; and search result output means for outputting, to the terminal, a search result of a search received from the search system in response to the output of the search query to the search system.

A search control method according to at least one embodiment of the present invention includes: generating, based on a chat message received from a terminal, a prompt to be output to a language model; outputting the prompt to the language model; outputting, to the terminal, a chat message based on an answer from the language model to the prompt; generating a search query based on a log related to exchange of a chat message with the terminal; outputting the search query to a search system; and outputting, to the terminal, a search result of a search received from the search system in response to the output of the search query to the search system.

An information storage medium according to at least one embodiment of the present invention is an information storage medium storing a program that causes a computer to execute: generating, based on a chat message received from a terminal, a prompt to be output to a language model; outputting the prompt to the language model; outputting, to the terminal, a chat message based on an answer from the language model to the prompt; generating a search query based on a log related to exchange of a chat message with the terminal; outputting the search query to a search system; and outputting, to the terminal, a search result of a search received from the search system in response to the output of the search query to the search system.

### BRIEF DESCRIPTION OF THE DRAWINGS

FIG. 1 is a diagram for illustrating an example of a configuration of a chat system in at least one embodiment of the present invention.

FIG. 2 is a view for illustrating an example of a chat screen.

FIG. 3 is a view for illustrating an example of the chat screen.

FIG. 4 is a functional block diagram for illustrating an example of functions of a search control system according to the at least one embodiment of the present invention.

FIG. 5A is a flowchart for illustrating an example of a flow of processing executed in the search control system according to the at least one embodiment of the present invention.

FIG. 5B is a flowchart for illustrating the example of the flow of the processing executed in the search control system according to the at least one embodiment of the present invention.

FIG. 6 is a functional block diagram for illustrating an example of functions of a search control system according to a modification example of the at least one embodiment of the present invention.

### DETAILED DESCRIPTION OF THE INVENTION

Now, description is given in detail of at least one embodiment of the present invention with reference to the drawings.

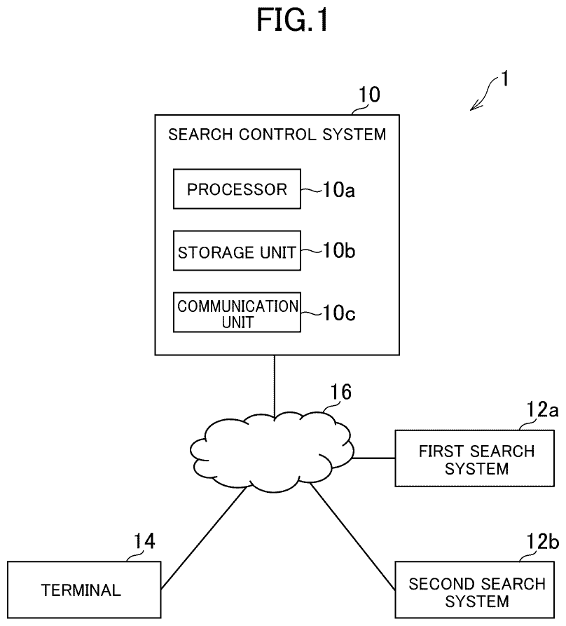

FIG. 1 is a diagram for illustrating an example of a configuration of a chat system 1 in at least one embodiment of the present invention. As illustrated in FIG. 1, the chat system 1 in the at least one embodiment includes a search control system 10, a search system 12 (a first search system 12a and a second search system 12b), and a terminal 14. The search control system 10, the first search system 12a, the second search system 12b, and the terminal 14 are connected to a computer network 16 such as the Internet.

The search control system 10 may be formed of a computer, for example, a server computer. The search control system 10 may include a processor 10a such as a CPU or a GPU, a storage unit 10b such as a memory or a hard disk drive, and a communication unit 10c such as a network interface card. The search control system 10 may include a plurality of computers or one computer.

The search system 12 (the first search system 12a and the second search system 12b) may be formed of a server computer including, for example, a CPU, a GPU, a memory, and a communication interface. Moreover, the search system 12 may include a plurality of computers or one computer.

The terminal 14 may be formed of a computer (for example, a personal computer, a smartphone, or a tablet terminal) including, for example, a CPU, a memory, a communication interface, an input device, and a display.

In the at least one embodiment, for example, a chat message is exchanged between the search control system 10 and the terminal 14. In this exchange, a search in the search system 12 is appropriately executed. In the search system 12, for example, a search for suggestion to the user (more specifically, for example, a search for generating options for a product or a service the purchase of which is suggested to a user) is executed.

In the at least one embodiment, for example, a search target of a search in the first search system 12a and a search target of a search in the second search system 12b are different from each other. Moreover, the search system 12 may execute a search having a product or a service as the search target. For example, the search by the first search system 12a may have, as the search target, data indicating products to be sold in online shopping, and the search by the second search system 12b may have, as the search target, data indicating travel packages.

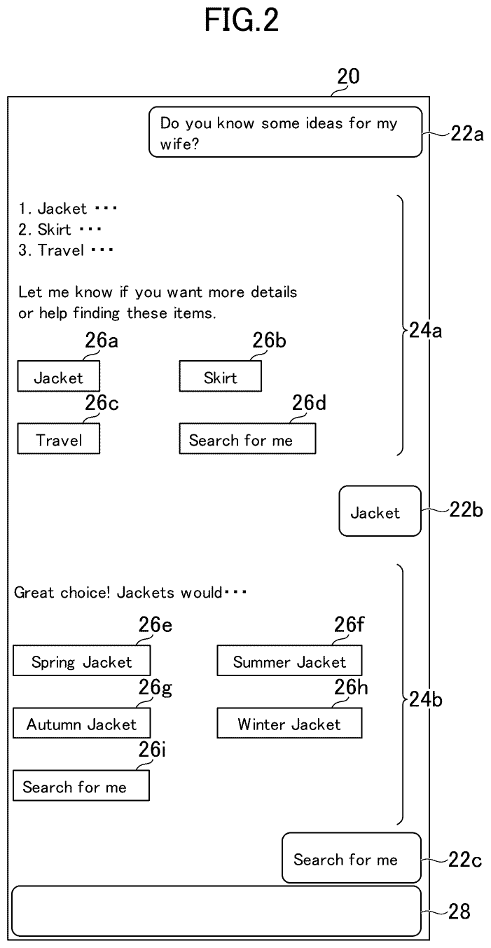

FIG. 2 is a view for illustrating an example of a chat screen 20 displayed on a display of the terminal 14 in the at least one embodiment. The chat screen 20 may be a screen which can be scrolled in a predetermined direction (for example, an up-down direction).

On the chat screen 20 illustrated in FIG. 2, user message images 22 (22a, 22b, and 22c) indicating chat messages input by the user who operates the terminal 14 are arranged.

Moreover, on the chat screen 20 illustrated in FIG. 2, answer message images 24 (24a and 24b) indicating chat messages transmitted from the search control system 10 to the terminal 14 in response to the chat messages received by the search control system 10 from the terminal 14 are arranged. Moreover, the answer message image 24 may include option images 26 which indicate options selectable by the user. In the example of FIG. 2, the answer message 24a includes an option image 26a, an option image 26b, an option image 26c, and an option image 26d. Moreover, the answer message 24b includes an option image 26e, an option image 26f, an option image 26g, an option image 26h, and an option image 26i.

Moreover, on the chat screen 20 illustrated in FIG. 2, an input form 28 for the user to input a chat message is arranged.

When the user inputs a character string to the input form 28, and executes a predetermined operation (for example, input of an enter key or a tap operation on a send button), a chat message including the character string input to the input form 28 is transmitted from the terminal 14 to the search control system 10.

Moreover, when the user executes an operation of selecting the option image 26 (for example, a tap operation on the option image 26), a chat message including a character string arranged on the selected option image 26 is transmitted from the terminal 14 to the search control system 10.

Moreover, the chat screen 20 having an added user message image 22 including the chat message transmitted from the terminal 14 to the search control system 10 is displayed on the display of the terminal 14.

On the chat screen 20 illustrated in FIG. 2, a situation in which a chat message “Search for me” is transmitted from the terminal 14 to the search control system 10 in response to the selection operation on the option image 26i is displayed.

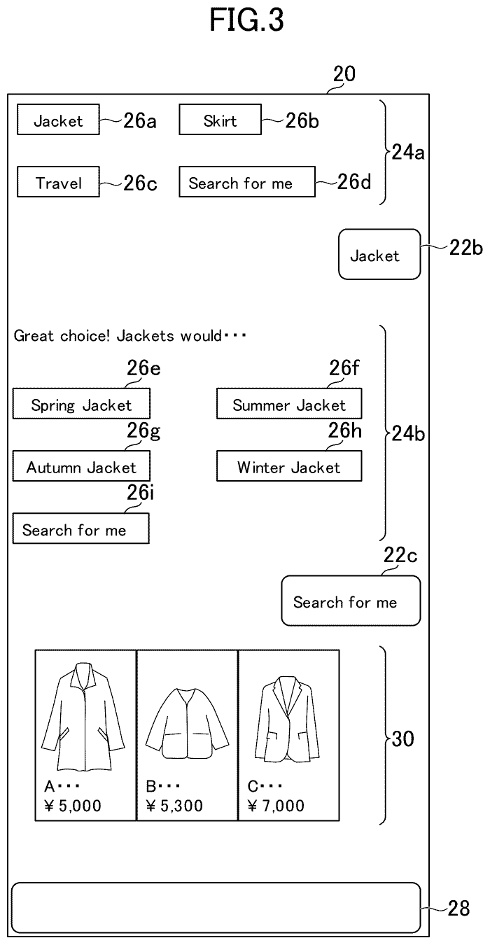

After that, in the at least one embodiment, for example, as illustrated in FIG. 3, a search result of the search executed in the search system 12 is transmitted from the search control system 10 to the terminal 14, and the chat screen 20 having an added search result image 30 indicating this search result is displayed on the display of the terminal 14. As illustrated in FIG. 3, this search result may indicate a product or a service. For example, as illustrated in FIG. 3, this search result may include an image of a product or a service, a name of a product or a service, and a price of a product or a service.

Moreover, as illustrated in FIG. 3, on the display of the terminal 14, the chat screen 20 on which the chat messages and the search results are arranged in chronological order may be displayed. For example, as illustrated in FIG. 3, the chat screen 20 on which the chat messages and the search results are arranged in chronological order from the older ones from the top to the bottom may be displayed.

Moreover, in the at least one embodiment, for example, by the user executing a predetermined operation (for example, a tap operation) on the search result displayed on the search result image 30, the screen displayed on the display of the terminal 14 transitions to a purchase page for purchasing the product or the service indicated by this search result. Then, the user comes to be able to purchase the product or the service via this purchase page.

As described above, in the at least one embodiment, the user can seamlessly acquire the search result obtained by the search system 12 in such a sense that the user is naturally chatting a human.

Description is now further given of functions of the search control system 10 according to the at least one embodiment and processing executed in the search control system 10.

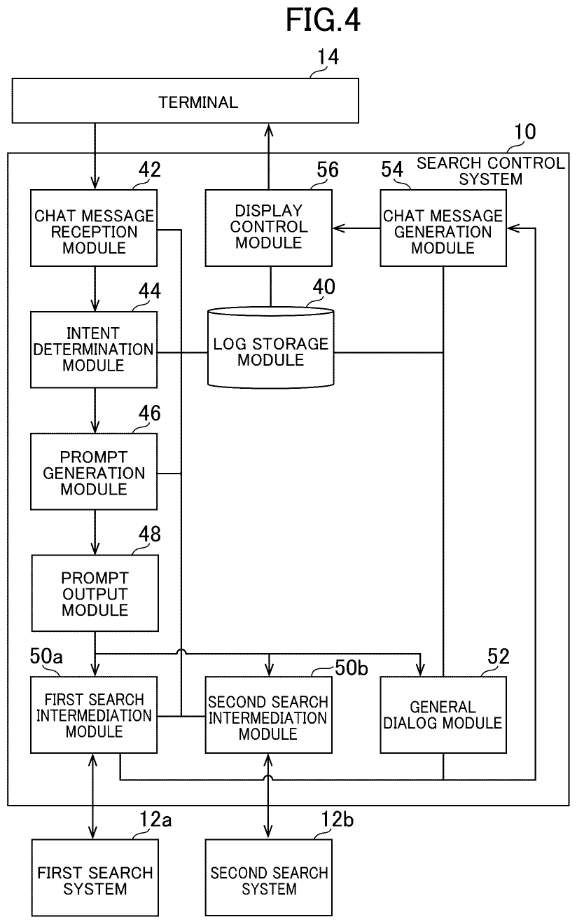

FIG. 4 is a functional block diagram for illustrating an example of functions implemented in the search control system 10 according to the at least one embodiment. In the search control system 10 according to the at least one embodiment, it is not required that all of the functions illustrated in FIG. 4 be implemented, and a function other than the functions illustrated in FIG. 4 may be implemented.

As illustrated in FIG. 4, the search control system 10 according to the at least one embodiment functionally includes, for example, a log storage module 40, a chat message reception module 42, an intent determination module 44, a prompt generation module 46, a prompt output module 48, a search intermediation module 50 (first search intermediation module 50a and second search intermediation module 50b), a general dialog module 52, a chat message generation module 54, and a display control module 56. The log storage module 40 is implemented mainly by the storage unit 10b. The chat message reception module 42 is implemented mainly by the communication unit 10c. The intent determination module 44, the prompt generation module 46, the prompt output module 48, the general dialog module 52, and the chat message generation module 54 are implemented mainly by the processor 10a. The first search intermediation module 50a, the second search intermediation module 50b, and the display control module 56 are implemented mainly by the processor 10a and the communication unit 10c.

The above-mentioned functions may be implemented by executing, in the search control system 10, a program installed on the search control system 10 being the computer, and including instructions corresponding to the above-mentioned functions. Moreover, this program may be supplied to the search control system 10 via a computer-readable information storage medium, for example, an optical disc, a magnetic disk, a magnetic tape, or a magneto-optical disk, or via the Internet or the like.

In the at least one embodiment, for example, the log storage module 40 stores logs related to the exchange of the chat messages between the search control system 10 and the terminal 14. For example, the log storage module 40 may store logs of the chat message received by the search control system 10 from the terminal 14 and the chat message output from the search control system 10 to the terminal 14. Here, for example, a chat message associated with a time stamp indicating a date and a time at which the chat message is received or output and a flag indicating whether this chat message is the chat message received by the search control system 10 or the chat message output by the search control system 10 may be accumulated in the log storage module 40.

In the at least one embodiment, for example, the chat message reception module 42 receives the chat message from the terminal 14. Moreover, in the at least one embodiment, for example, the chat message reception module 42 stores this chat message in the log storage module 40.

In the at least one embodiment, for example, the intent determination module 44 uses, an existing intent determination technology which uses a natural language processing (NLP) model, a large language model (LLM), a knowledge graph, or the like to determine an intent of the user based on the chat message received from the terminal 14.

For example, the intent determination module 44 may include a trained language model (for example, an LLM) for intent determination. This language model is hereinafter referred to as “intent determination LLM.” Moreover, the intent determination module 44 may output, to the intent determination LLM, a prompt including, for example, a template “Refer to a log at the following location to determine the intent” and a character string indicating the location (for example, a URL) of the log storage module 40. Then, the intent determination module 44 may determine, as the intent of the user, an answer output from the intent determination LLM in response to the output of this prompt. As described above, the intent determination module 44 may determine the intent of the user based on the logs stored in the log storage module 40.

Here, the intent determination module 44 may determine the intent of the user based on, for example, at least one of the logs of the chat messages received from the terminal 14 or the logs of the chat messages output to the terminal 14 stored in the log storage module 40.

Moreover, the intent of the user may be determined based on a chat message group including chat messages each weighted such that the weight is higher as a date and time of the reception or the output of the chat message becomes later.

Moreover, the intent determination module 44 may determine the intent of the user based on the latest chat message received from the terminal 14. For example, the intent determination module 44 may output, to the intent determination LLM, a prompt including, for example, a template “Determine the intent based on the following message” and the latest chat message received from the terminal 14. Then, the intent determination module 44 may determine, as the intent of the user, an answer output from the intent determination LLM in response to the output of this prompt.

In the at least one embodiment, for example, the prompt generation module 46 generates, based on the chat message received from the terminal 14, the prompt to be output to the language model (for example, an LLM). Here, for example, the prompt generation module 46 may generate a prompt including the chat message received by the chat message reception module 42.

In the at least one embodiment, for example, the prompt output module 48 outputs the prompt generated by the prompt generation module 46 to the language model.

Here, each of the first search intermediation module 50a, the second search intermediation module 50b, and the general dialog module 52 may include a trained language model (for example, an LLM). The language model included in the first search intermediation module 50a is hereinafter referred to as “first LLM,” the language model included in the second search intermediation module 50b is hereinafter referred to as “second LLM,” and the language model included in the general dialog module 52 is hereinafter referred to as “third LLM.”

In addition, the prompt output module 48 may output, for example, the prompt generated by the prompt generation module 46 to any one of the first LLM, the second LLM, or the third LLM.

Here, the intent determination module 44 may determine the language model (hereinafter referred to as “target model”) being the output destination of the prompt out of the plurality of language models based on the logs stored in the log storage module 40. For example, the intent determination module 44 may determine the intent of the user based on the logs stored in the log storage module 40, and may determine the target model out of the plurality of language models based on the determined intent. Here, the intent determination module 44 may store, for example, data on the intent and the language model associated with each other. In addition, the intent determination module 44 may determine, as the target model, the language model associated with the intent determined by the intent determination module 44 in this data. Then, the prompt output module 48 may output the prompt to the determined target model.

Specifically, for example, when the intent of the user is determined to be the purchase of a product (for example, purchase of a present for a partner), the intent determination module 44 may determine the first LLM as the target model. Moreover, for example, when the intent of the user is determined to be a travel (for example, a travel with a partner), the intent determination module 44 may determine the second LLM as the target model. Moreover, when the intent of the user is none of the above-mentioned intents, the intent determination module 44 may determine the third LLM as the target model. Then, the prompt may be output to the target model determined as described above.

Moreover, in the at least one embodiment, the intent determination module 44 may repeatedly execute the processing of determining the target model out of the plurality of language models based on the logs stored in the log storage module 40. For example, the intent determination module 44 may execute the processing of determining the target model each time a chat message is received from the terminal 14. Then, the prompt output module 48 may output the prompt based on a chat message received from the terminal 14 to the target model at the time of receiving the chat message.

In the at least one embodiment, for example, the search intermediation module 50 (in the at least one embodiment, for example, the first search intermediation module 50a and the second search intermediation module 50b) generates an answer to the received prompt. In the at least one embodiment, it is assumed that knowledge relating to the search target (for example, a product to be sold in the online shopping) in the search in the first search system 12a is registered in advance in (learned in advance by) the first LLM being the language model included in the first search intermediation module 50a. Moreover, in the at least one embodiment, it is assumed that knowledge relating to the search target (for example, a travel package) in the search in the second search system 12b is registered in advance in (learned in advance by) the second LLM being the language model included in the second search intermediation module 50b. Moreover, in the at least one embodiment, it is assumed that the first LLM and the second LLM can refer to the logs stored in the log storage module 40.

The search intermediation module 50 may determine, based on the logs stored in the log storage module 40, whether or not information (context) sufficient for the execution of the search by the search system 12 has been acquired.

For example, when the target model is the first LLM, the prompt generation module 46 may generate a prompt including a template “Refer to a log at the following location to determine whether or not a product search can be executed” and a character string indicating the location (for example, the URL) of the log storage module 40. Then, when the target model is the first LLM, the prompt output module 48 may output this prompt to the first LLM. After that, when the answer output from the first LLM in response to this prompt is a positive answer (for example, “Possible.”), the first search intermediation module 50a may determine that the information (context) sufficient for the execution of the search by the first search system 12a has been acquired.

Moreover, when the target model is the second LLM, the prompt generation module 46 may generate a prompt including a template “Refer to a log at the following location to determine whether or not a travel package search can be executed” and a character string indicating the location (for example, the URL) of the log storage module 40. The prompt output module 48 may output this prompt to the second LLM. Then, when the answer output from the second LLM in response to this prompt is a positive answer (for example, “Possible.”), the second search intermediation module 50b may determine that the information (context) sufficient for the execution of the search by the second search system 12b has been acquired.

Moreover, for example, the search intermediation module 50 may determine whether or not, from the logs stored in the log storage module 40, at least one predetermined attribute (for example, the gender, the age group, the address, hobby, and the number of persons in household) can be extracted. Then, when it is determined that the extraction is possible, the search intermediation module 50 may determine that the information (context) sufficient for the execution of the search by the search system 12 has been acquired. The attributes in this determination in the first search intermediation module 50a and the attributes in this determination in the second search intermediation module 50b may be the same as or different from each other.

Then, as described later, when it is determined that the information (context) sufficient for the execution of the search by the search system 12 has been acquired, a predetermined chat message (for example, a chat message including the option image 26i on which a character string “Search for me” is arranged) indicating that the search is executable may be transmitted to the terminal 14.

Moreover, in the at least one embodiment, for example, the search intermediation module 50 may generate a search query based on the log related to the exchange of the chat messages between the search control system 10 and the terminal 14. This search query may be a keyword to be used in the search for a product or a service. Here, for example, the search intermediation module 50 may generate the search query in response to satisfaction of a predetermined search execution condition. The search execution condition may be, for example, a condition that a predetermined character string (for example, “Search for me”) is included in the chat message received by the chat message reception module 42. This predetermined character string is not required to be the character string “Search for me,” and may be a character string, for example, in Japanese. Moreover, the search execution condition may be a condition that it is determined that the information (context) sufficient for the execution of the search by the search system 12 has been acquired.

Here, the prompt generation module 46 may generate a search query generation prompt which gives an instruction to generate the search query based on the logs stored in the log storage module 40 in response to, for example, the chat message received by the chat message reception module 42 satisfying the predetermined search execution condition, and the prompt output module 48 may output this search query generation prompt to the language model. Then, the search intermediation module 50 may generate the search query based on the answer output from the language model in response to “ [symbol] (Search for . . . )” the output of the search query generation prompt to this language model.

For example, when the target model is the first LLM, the search query generation prompt generated by the prompt generation module 46 may be output to the first LLM. Then, the first search intermediation module 50a may generate the search query based on the answer output from the first LLM in response to the output of this search query generation prompt to the first LLM.

For example, the prompt generation module 46 may generate a prompt including a template “Refer to a log at the following location to generate a keyword group in Japanese appropriate for a product search as one sentence” and a character string indicating the location (for example, the URL) of the log storage module 40, and the prompt output module 48 may output this prompt to the first LLM. As another example, the prompt generation module 46 may generate a prompt including content of a log to be referred to and an instruction to generate a search query, and the prompt output module 48 may output this prompt to the first LLM. Then, the first search intermediation module 50a may acquire, as the search query, the answer output from the first LLM in response to this prompt.

Moreover, for example, when the target model is the second LLM, the search query generation prompt generated by the prompt generation module 46 may be output to the second LLM. Then, the second search intermediation module 50b may generate the search query based on the answer output from the second LLM in response to the output of this search query generation prompt to the second LLM.

For example, the prompt generation module 46 may generate a prompt including a template “Refer to a log at the following location in Japanese to generate a keyword group appropriate for a travel package search as one sentence” and a character string indicating the location (for example, the URL) of the log storage module 40, and the prompt output module 48 may output this prompt to the second LLM. As another example, the prompt generation module 46 may generate a prompt including content of a log to be referred to and an instruction to generate a search query, and the prompt output module 48 may output this prompt to the second LLM. Then, the second search intermediation module 50b may acquire, as the search query, the answer output from the second LLM in response to this prompt.

The search intermediation module 50 may generate the search query based on the chat message received from the terminal 14 (for example, the latest chat message received from the terminal 14).

The search query generated by the search intermediation module 50 is hereinafter referred to as “generated search query.”

Further, in the at least one embodiment, for example, the search intermediation module 50 outputs the generated search query to the search system 12 (for example, the search system 12 associated with this search intermediation module 50). Then, in the at least one embodiment, for example, the search intermediation module 50 receives a search result output from this search system 12 in response to the output of the generated search query to this search system 12.

For example, the first search intermediation module 50a outputs the generated search query generated by the first search intermediation module 50a to the first search system 12a. Then, in the at least one embodiment, for example, the first search intermediation module 50a receives the search result output from the first search system 12a in response to the output of the generated search query to the first search system 12a.

Moreover, in the at least one embodiment, for example, the second search intermediation module 50b outputs the generated search query generated by the second search intermediation module 50b to the second search system 12b. Then, in the at least one embodiment, for example, the second search intermediation module 50b receives the search result output from the second search system 12b in response to the output of the generated search query to the second search system 12b.

In the at least one embodiment, when the search has been executed in the search system 12, the prompt generation module 46 may generate a prompt including the search result in the search in this search system 12, and the prompt output module 48 may output this prompt to the language model. This prompt may include the chat message received by the chat message reception module 42. Moreover, this prompt may include an instruction to refer to the logs stored in the log storage module 40. Moreover, the search intermediation module 50 may acquire the answer output from this language model in response to this prompt.

For example, when the target model is the first LLM and the search has been executed in the first search system 12a, the prompt generation module 46 may generate a prompt including the search result in the search in the first search system 12a, and the prompt output module 48 may output this prompt to the first LLM. Then, the first search intermediation module 50a may acquire the answer output from the first LLM in response to this prompt.

Moreover, for example, when the target model is the second LLM and the search has been executed in the second search system 12b, the prompt generation module 46 may generate a prompt including the search result in the search in the second search system 12b, and the prompt output module 48 may output this prompt to the second LLM. Then, the second search intermediation module 50b may acquire the answer output from the second LLM in response to this prompt.

Meanwhile, when the search has not been executed in the search system 12, the prompt generation module 46 may generate a prompt including the chat message received by the chat message reception module 42, and the prompt output module 48 may output this prompt to the language model. This prompt may include an instruction to refer to the logs stored in the log storage module 40. Moreover, the search intermediation module 50 may acquire the answer output from this language model in response to this prompt.

For example, when the target model is the first LLM and the search has not been executed in the first search system 12a, the prompt generation module 46 may generate a prompt including the chat message received by the chat message reception module 42, and the prompt output module 48 may output this prompt to the first LLM. Then, the first search intermediation module 50a may acquire the answer output from the first LLM in response to this prompt.

Moreover, for example, when the target model is the second LLM and the search has not been executed in the second search system 12b, the prompt generation module 46 may generate a prompt including the chat message received by the chat message reception module 42, and the prompt output module 48 may output this prompt to the second LLM. Then, the second search intermediation module 50b may acquire the answer output from the second LLM in response to this prompt.

In the at least one embodiment, for example, the general dialog module 52 generates an answer to the received prompt. In the at least one embodiment, it is assumed that the third LLM can refer to the logs stored in the log storage module 40.

For example, when the target model is the third LLM, the prompt generation module 46 may generate a prompt including the chat message received by the chat message reception module 42, and the prompt output module 48 may output this prompt to the third LLM. This prompt may include an instruction to refer to the logs stored in the log storage module 40. Moreover, the general dialog module 52 may acquire the answer output from the third LLM in response to this prompt.

In the at least one embodiment, for example, the chat message generation module 54 generates the chat message to be output to the terminal 14.

For example, when the target model is the first LLM, the chat message generation module 54 may generate a chat message including the answer generated by the first LLM. Here, when the first search intermediation module 50a receives the search result output from the first search system 12a, the chat message generation module 54 may generate a chat message including the search result received by the first search intermediation module 50a from the first search system 12a and the answer generated by the first LLM.

Moreover, for example, when the target model is the second LLM, the chat message generation module 54 may generate a chat message including the answer generated by the second LLM. Here, when the second search intermediation module 50b receives the search result output from the second search system 12b, the chat message generation module 54 may generate a chat message including the search result received by the second search intermediation module 50b from the second search system 12b and the answer generated by the second LLM.

Moreover, when the target model is the third LLM, the chat message generation module 54 may generate a chat message including the answer generated by the third LLM.

Moreover, in the at least one embodiment, the chat message generation module 54 may generate a predetermined chat message indicating that the search is executable in response to satisfaction of a given search executability condition. For example, the chat message generation module 54 may generate a chat message including the option image 26i on which the character string “Search for me” is arranged in response to the satisfaction of the given search executability condition. Here, the search executability condition may be, for example, a condition that it is determined that the information (context) sufficient for the execution of the search has been acquired.

Moreover, to the first LLM, the second LLM, or the third LLM, a prompt including an instruction to generate options to be presented to the user may be output. Moreover, the chat message generation module 54 may generate a chat message including an option image 26 associated with each of one or more options output from those LLM in response to the output of this prompt.

In the at least one embodiment, for example, the display control module 56 displays the chat screen 20 on the display of the terminal 14.

The display control module 56 may generate, for example, in response to the reception of the chat message from the terminal 14 by the chat message reception module 42, the chat screen 20 to which this chat message is added, and may transmit this chat screen 20 to the terminal 14. Then, the terminal 14 may display, in response to the reception of this chat screen 20, this chat screen 20 on the display of the terminal 14.

Moreover, for example, the display control module 56 may generate, in response to the chat message generation module 54 generating the chat message, the chat screen 20 to which this chat message is added, and may output this chat screen 20 to the terminal 14. Here, as described above, this chat message may include the search result (for example, the search result image 30) received from the search system 12. This chat message may include a part of the search result received from the search system 12 (for example, the search result image 30 indicating a part of the search result received from the search system 12). Then, the terminal 14 may display, in response to the reception of this chat screen 20, this chat screen 20 on the display of the terminal 14.

As described above, the display control module 56 in the at least one embodiment plays a role of a chat message output module which outputs, to the terminal 14, the chat message based on the answer from the language model in response to the prompt. Moreover, the display control module 56 in the at least one embodiment plays a role of a search result output module which outputs, to the terminal 14, the search result received from the search system 12 in response to the output of the generated search query to the search system 12.

In the at least one embodiment, the search intermediation module 50 may output the generated search query to the search system 12 in response to the reception of a search request for output of a predetermined chat message indicating that a search is executable (for example, reception of the chat message “Search for me” in response to the output of a chat message including the option image 26i on which the character string “Search for me” is arranged).

For example, in response to the first search intermediation module 50a determining that the information (context) sufficient for the execution of the search has been acquired, the chat message generation module 54 may generate a chat message including the option image 26i on which the character string “Search for me” is arranged. Then, the display control module 56 may transmit the chat screen 20 including the option image 26i to the terminal 14. After that, in response to reception of the chat message “Search for me” in response to the transmission of this chat screen 20, the first search intermediation module 50a may generate the generated search query, and may output the generated search query having been generated to the first search system 12a.

Moreover, for example, in response to the second search intermediation module 50b determining that the information (context) sufficient for the execution of the search has been acquired, the chat message generation module 54 may generate a chat message including the option image 26i on which the character string “Search for me” is arranged. Then, the display control module 56 may transmit the chat screen 20 including the option image 26i to the terminal 14. After that, in response to reception of the chat message “Search for me” in response to the transmission of this chat screen 20, the second search intermediation module 50b may generate the generated search query, and may output the generated search query having been generated to the second search system 12b.

It is not required for the search intermediation module 50 to generate the generated search query in response to the reception of the search request in response to the output of the predetermined chat message indicating that the search is executable, and to output the generated search query to the search system 12. Even in a situation in which the predetermined chat message indicating that the search is executable is not output, in response to the reception of the search request, the search intermediation module 50 may generate the generated search query, and may output the generated search query to the search system 12. For example, in response to the chat message reception module 42 receiving a message including a predetermined character string (for example, the character string in Japanese), the search intermediation module 50 may generate the generated search query, and may output the generated search query having been generated to the search system 12.

As described above, in the at least one embodiment, each of the plurality of language models (in the above-mentioned example, the first LLM, the second LLM, and the third LLM) is any one of a language model associated with the search system 12 or a language model not associated with the search system 12. In the above-mentioned example, the first LLM and the second LLM are the language models associated with the search system 12 and the third LLM is the language model not associated with the search system 12.

[symbol] (Search for . . . )” [symbol] of language models are associated with the search systems 12 having search targets different from one another. In the above-mentioned example, the first LLM is associated with the first search system 12a, and the second LLM is associated with the second search system 12b.

Moreover, in the at least one embodiment, for example, the generated search query is output to the search system 12 associated with the target model in response to the satisfaction of the above-mentioned search execution condition in the situation in which the target model is the language model associated with the search system 12.

For example, the first search intermediation module 50a outputs the generated search query to the first search system 12a in response to the satisfaction of the above-mentioned search execution condition in the situation in which the target model is the first LLM. Then, the display control module 56 outputs, to the terminal 14, the search result for the search target of the first search system 12a received from the first search system 12a in response to the output of the generated search query to the first search system 12a.

Moreover, the second search intermediation module 50b outputs the generated search query to the second search system 12b in response to the satisfaction of the above-mentioned search execution condition in the situation in which the target model is the second LLM. Then, the display control module 56 outputs, to the terminal 14, the search result for the search target of the second search system 12b received from the second search system 12b in response to the output of the generated search query to the second search system 12b.

Moreover, as described above, all of the plurality of language models (in the above-mentioned example, the first LLM, the second LLM, and the third LLM) may be capable of referring to the logs stored in the log storage module 40. Moreover, the log stored in the log storage module 40 may be the log related to the exchange of the chat message via the plurality of language models.

In the at least one embodiment, the prompt generation module 46 may store the prompt generated by the prompt generation module 46 in the log storage module 40. Moreover, the display control module 56 may store the chat screen 20 generated by the display control module 56 in the log storage module 40.

Moreover, in the at least one embodiment, the first search intermediation module 50a may store the generated search query generated by the first search intermediation module 50a in the log storage module 40. Moreover, the second search intermediation module 50b may store the generated search query generated by the second search intermediation module 50b in the log storage module 40.

Moreover, in the at least one embodiment, the log stored in the log storage module 40 may include the search result in the search executed by the search system 12. For example, the first search intermediation module 50a may store, in the log storage module 40, the search result received by the first search intermediation module 50a from the first search system 12a. Moreover, for example, the second search intermediation module 50b may store, in the log storage module 40, the search result received by the second search intermediation module 50b from the second search system 12b.

Moreover, the various types of data stored in the log storage module 40 as described above may be referred to in the above-mentioned various types of processing.

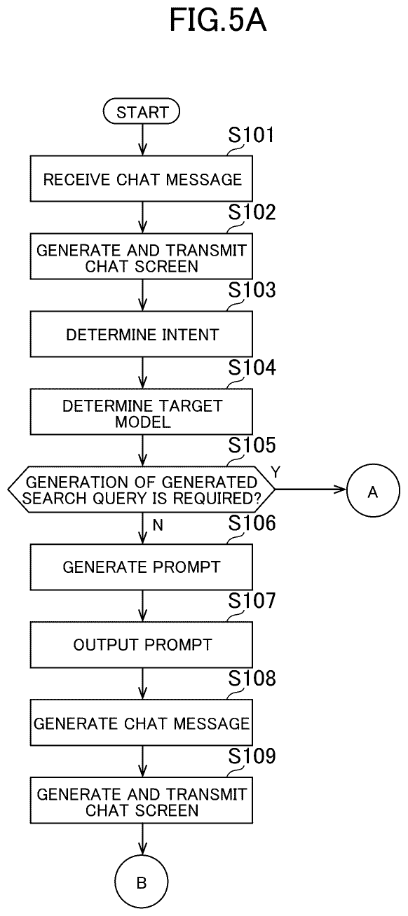

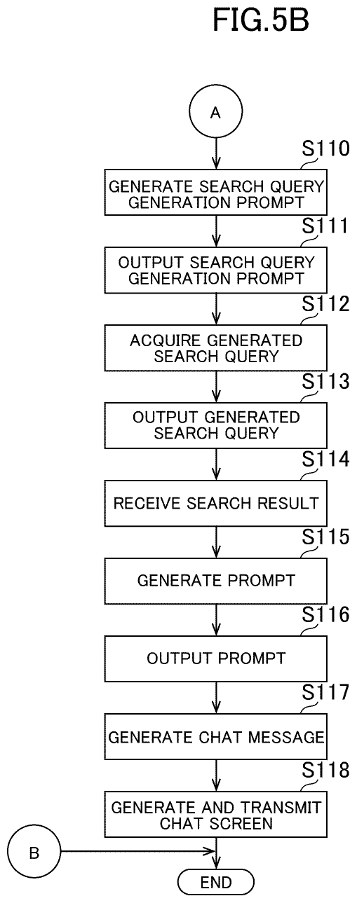

Now, with reference to flowcharts exemplified in FIG. 5A and FIG. 5B, description is given of an example of a flow of the processing executed in the search control system 10 in the at least one embodiment.

When the chat message reception module 42 receives a chat message from the terminal 14 (Step S101), the display control module 56 generates the chat screen 20 including this chat message, and transmits this chat screen 20 to the terminal 14 (Step S102). The terminal 14 updates, in response to the reception of the chat screen 20, the chat screen 20 displayed on the display to the received chat screen 20.

Then, the intent determination module 44 determines the intent of the user (Step S103). After that, the intent determination module 44 determines a target model based on the intent determined in the processing step of Step S103 (Step S104).

Then, the prompt generation module 46 determines, based on the chat message received in the processing step of Step S101, whether or not the generation of a generated search query is required (Step S105).

When it is determined that the generation of a generated search query is not required (N in Step S105), the prompt generation module 46 generates a prompt including the chat message received in the processing step of Step S101 (Step S106), and the prompt output module 48 outputs the prompt generated in the processing step of Step S106 to the target model (Step S107).

Then, the chat message generation module 54 generates a chat message based on an answer being the output from the target model in response to the prompt output to the target model in the processing step of Step S107 (Step S108).

Then, the display control module 56 generates the chat screen 20 including the chat message generated in the processing step of Step S108, and transmits this chat screen 20 to the terminal 14 (Step S109). After that, the processing in this processing example is finished. The terminal 14 updates, in response to the reception of the chat screen 20, the chat screen 20 displayed on the display to the received chat screen 20.

When it is determined that the generation of a generated search query is required in the processing step of Step S105 (Y in Step S105), the prompt generation module 46 generates a search query generation prompt (Step S110). The prompt output module ?outputs, to the target model, the search query generation prompt generated in the processing step of Step S110 (Step S111).

Then, the search intermediation module 50 including the target model acquires a generated search query being the output from this target model in response to the search query generation prompt output to this target model in the processing step of Step S111 (Step S112).

Then, the search intermediation module 50 outputs the generated search query acquired in the processing step of Step S112 to the search system 12 associated with this search intermediation module 50 (Step S113), and the search intermediation module 50 receives a search result output from this search system 12 in response to the output of the generated search query to this search system 12 (Step S114).

Then, the prompt generation module 46 generates a prompt including the search result received in the processing step of Step S114 (Step S115), and the prompt output module 48 outputs the prompt generated in the processing step of Step S115 to the target model (Step S116).

Then, the chat message generation module 54 generates a chat message based on the search result received in the processing step of Step S114 and an answer being the output from the target model in response to the prompt output to the target model in the processing step of Step S116 (Step S117).

Then, the display control module 56 generates the chat screen 20 including the chat message generated in the processing step of Step S117, and transmits this chat screen 20 to the terminal 14 (Step S118). After that, the processing in this processing example is finished. The terminal 14 updates, in response to the reception of the chat screen 20, the chat screen 20 displayed on the display to the received chat screen 20.

The processing steps of Step S101 to Step S118 are executed each time the chat message reception module 42 receives the chat message.

According to the at least one embodiment, as described above, the user can seamlessly acquire the search result obtained by the search system 12 in such a sense that the user is naturally chatting a human through the chat screen 20. In the at least one embodiment, all of the plurality of language models (in the above-mentioned example, the first LLM, the second LLM, and the third LLM) may be set in advance to generate the answer in a common communication style.

For example, a prompt “communication style: -use an emoji, when necessary, to maintain a bright and positive tone. -express excitement caused by a positive user experience. -use the first person to give a more personal impression (example: “I recommend . . . ”). -provide non-authoritative advice or proposal to behave as a kind assistant± may be output in advance to all of the first LLM, the second LLM, and the third LLM.

With this configuration, even when the chat via the plurality of language models is being executed, it is possible to prevent the user from feeling a sense of discomfort.

Moreover, in the at least one embodiment, it is not required that, as described above, the number of language models to be used for the generation of the chat message be three (in the above-mentioned example, the first LLM, the second LLM, and the third LLM), and it is also not required that the number be two or more.

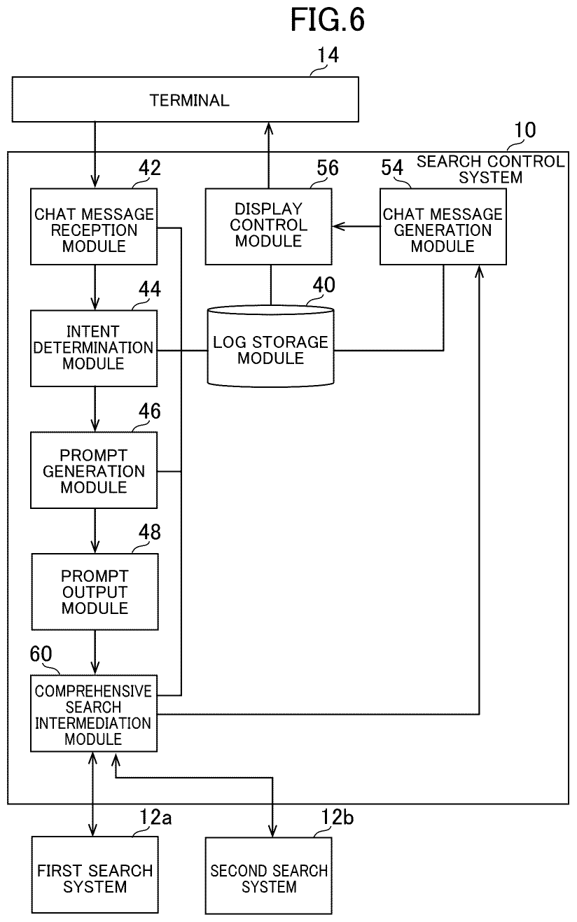

For example, as illustrated in FIG. 6, instead of the search control system 10 including the first search intermediation module 50a, the second search intermediation module 50b, and the general dialog module 52, the search control system 10 may include a comprehensive search intermediation module 60. The comprehensive search intermediation module 60 may include a trained language model (for example, an LLM). The language model included in the comprehensive search intermediation module 60 is hereinafter referred to as “comprehensive LLM.”

Moreover, in the prompt generation module 46, a plurality of templates may be stored in advance. Further, the intent determination module 44 may repeatedly execute processing of determining a target template out of the plurality of templates based on the logs stored in the log storage module 40. For example, the intent determination module 44 may execute the processing of determining the target template each time a chat message is received from the terminal 14.

Here, the intent determination module 44 may store, for example, data on the intent and the template associated with each other. Moreover, the intent determination module 44 may determine, as a target template, the template associated with the intent determined by the intent determination module 44 in this data.

Moreover, the prompt generation module 46 may generate a prompt based on a chat message received from the terminal 14 and the target template at the time receiving this chat message. For example, the prompt generation module 46 may generate a prompt including the chat message received by the chat message reception module 42 and the target template. Then, the prompt output module 48 may output this prompt to the comprehensive LLM.

Moreover, each of the plurality of templates may be any one of a template associated with the search system 12 or a template not associated with the search system 12. Moreover, the plurality of templates may be associated with the search systems 12 having search targets different from one another.

For example, the plurality of templates may be a first template associated with the first search system 12a, a second template associated with the second search system 12b, and a third template associated with none of the search systems 12. Here, the first template may include information on the first search system 12a (for example, a URL of the first search system 12a). Moreover, the second template may include information on the second search system 12b (for example, a URL of the second search system 12b).

Moreover, the generated search query may be output to the search system 12 associated with the target template in response to the satisfaction of the above-mentioned search execution condition in the situation in which the target template is the template associated with the search system 12. Moreover, the search result which is received from the search system 12 in response to the output of the generated search query to this search system 12 and which is obtained for the search target of the search system 12 may be output to the terminal 14.

For example, the comprehensive search intermediation module 60 may output the generated search query to the first search system 12a in response to the satisfaction of the above-mentioned search execution condition in the situation in which the target template is the first template. Then, the display control module 56 may output, to the terminal 14, the search result for the search target of the first search system 12a received from the first search system 12a in response to the output of the generated search query to the first search system 12a.

Moreover, the comprehensive search intermediation module 60 may output the generated search query to the second search system 12b in response to the satisfaction of the above-mentioned search execution condition in the situation in which the target template is the second template. Then, the display control module 56 may output, to the terminal 14, the search result for the search target of the second search system 12b received from the second search system 12b in response to the output of the generated search query to the second search system 12b.

It should be noted that the present invention is not limited to the above-mentioned at least one embodiment.

For example, the language model in the at least one embodiment is not required to be the large language model (LLM). For example, the language model in the at least one embodiment may be an n-gram model, a recurrent neural network (RNN), a Seq2Seq model, a word embedding model, or the like.

Moreover, the search target of the search in the search system 12 in the at least one embodiment is not limited to a product and a service.

Moreover, it is not required that the number of search systems 12 included in the chat system 1 in the at least one embodiment be two.

Moreover, the search intermediation module 50 and the search system 12 is not required to be associated in a one-to-one manner. For example, the first search intermediation module 50a may be associated with the plurality of search systems 12. Moreover, the second search intermediation module 50b may be associated with the plurality of search systems 12.

Moreover, at least some of the above-mentioned trained language models may be, instead of being included in the search control system 10, included in an external system capable of communicating to and from the search control system 10.

Further, the specific character strings and numerical values described above and the specific character strings and numerical values in the drawings are merely exemplary, and the present invention is not limited to those character strings and numerical values.

Moreover, for example, the search control system may have the following configurations.

### 1

A search control system, including:
prompt generation means for generating, based on a chat message received from a terminal, a prompt to be output to a language model;
prompt output means for outputting the prompt to the language model;
chat message output means for outputting, to the terminal, a chat message based on an answer from the language model in response to the prompt;
search query generation means for generating a search query based on a log related to exchange of a chat message with the terminal;
search query output means for outputting the search query to a search system; and
search result output means for outputting, to the terminal, a search result of a search received from the search system in response to the output of the search query to the search system.

### 2

The search control system according to Item [1],
wherein the search query generation means is configured to generate a search query generation prompt which gives an instruction to generate the search query based on the log, and
wherein the search query generation means is configured to generate the search query based on an answer output from the language model in response to the output of the search query generation prompt to the language model.

### 3

The search control system according to Item [1] or [2], further including determination means for repeatedly executing processing of determining, based on the log, a target model out of a plurality of the language models,
wherein the prompt output means is configured to output a prompt based on a chat message received from the terminal, to the target model at a time of receiving the chat message, and
wherein the log is a log related to exchange of a chat message via the plurality of the language models.

### 4

The search control system according to Item [3], wherein the determination means is configured to execute processing of determining the target model each time a chat message is received from the terminal.

### 5

The search control system according to Item [3] or [4],
wherein each of the plurality of the language models is any one of a language model associated with a search system or a language model unassociated with a search system, and
wherein the search query output means is configured to output, in a situation in which the target model is a language model associated with a search system, the search query to the search system associated with the target model in response to satisfaction of a given condition.

### 6

The search control system according to any one of Items [3] to [5],
wherein the plurality of the language models are associated with search systems having search targets different from one another,
wherein the search query output means is configured to output the search query to a search system associated with the target model in response to satisfaction of a given condition, and
wherein the search result output means is configured to output, to the terminal, a search result which is received from the search system in response to the output of the search query to the search system and which is obtained for a search target of the search system.

### 7

The search control system according to any one of Items [3] to [6], wherein all of the plurality of the language models

### 8 are allowed to refer to the log.

The search control system according to any one of Items [3] to [7], wherein all of the plurality of the language models are set in advance to generate an answer in a common communication style.

### 9

The search control system according to Item [1] or [2], further including determination means for repeatedly executing processing of determining, based on the log, a target template out of a plurality of templates, and
wherein the prompt output means is configured to output, to the language model, a prompt based on a chat message received from the terminal and on the target template at a time of receiving the chat message.

### 10

The search control system according to Item [9], wherein the determination means is configured to execute processing of determining the target template each time a chat message is received from the terminal.

### 11

The search control system according to Item [9] or [10],
wherein each of the plurality of templates is any one of a template associated with a search system or a template unassociated with a search system, and
wherein the search query output means is configured to output, in a situation in which the target template is a template associated with a search system, the search query to the search system associated with the target template in response to satisfaction of a given condition.

### 12

The search control system according to any one of Items [9] to [11],
wherein the plurality of templates are associated with search systems having search targets different from one another,
wherein the search query output means is configured to output the search query to a search system associated with the target template in response to satisfaction of a given condition, and
wherein the search result output means is configured to output, to the terminal, a search result which is received from the search system in response to the output of the search query to the search system and which is obtained for a search target of the search system.

### 13

The search control system according to any one of Items [1] to [12],
wherein the chat message output means is configured to output a predetermined chat message indicating that a search is executable in response to satisfaction of a given condition, and
wherein the search query output means is configured to output the search query to the search system in response to reception of a search request in response to the output of the predetermined chat message.

### 14

The search control system according to Item [13], wherein the search query output means is configured to output the search query to the search system in response to reception of a chat message indicating that a search is requested for the output of the predetermined chat message.

### 15

The search control system according to any one of Items [1] to [14], wherein the log includes a search result in the search.

### 16

The search control system according to any one of Items [1] to [15], wherein the search system is configured to execute a search having, as a search target, one of a product or a service.

### 17

The search control system according to any one of Items [1] to [16], wherein the search query is a keyword to be used for a search for one of a product or a service.

### 18

The search control system according to any one of Items [1] to [17], wherein the search result indicates one of a product or a service.

### 19

The search control system according to any one of Items [1] to [18], further including the terminal, wherein the terminal includes display means for displaying a screen on which chat messages and the search results are arranged in chronological order. While there have been described what are at present considered to be certain embodiments of the invention, it will be understood that various modifications may be made thereto, and it is intended that the appended claims cover all such modifications as fall within the true spirit and scope of the invention.

What is claimed is:

1. A search control system, comprising:
at least one processor; and
at least one memory device storing instructions which, when executed by the at least one processor, cause the at least one processor to perform operations comprising:
generating, based on a chat message received from a terminal, a prompt to be output to a language model;
outputting the prompt to the language model;
outputting, to the terminal, a chat message based on an answer from the language model to the prompt;
generating a search query based on a log related to exchange of a chat message with the terminal;
outputting the search query to a search system; and
outputting, to the terminal, a search result of a search received from the search system in response to the output of the search query to the search system.

2. The search control system according to claim 1,
wherein the generating the search query includes generating a search query generation prompt which gives an instruction to generate the search query based on the log, and
wherein the generating the search query includes generating the search query based on an answer output from the language model in response to output of the search query generation prompt to the language model.

3. The search control system according to claim 1,
wherein the operations further comprise repeatedly executing processing of determining, based on the log, a target model out of a plurality of the language models,
wherein the outputting the prompt to the language model includes outputting a prompt based on a chat message received from the terminal, to the target model at a time of receiving the chat message, and
wherein the log is a log related to exchange of a chat message via the plurality of the language models.

4. The search control system according to claim 3, wherein the processing of determining the target model is processing of determining the target model each time a chat message is received from the terminal.

5. The search control system according to claim 3,
wherein each of the plurality of the language models is any one of a language model associated with a search system or a language model unassociated with a search system, and
wherein the outputting the search query to the search system includes outputting, in a situation in which the target model is a language model associated with a search system, the search query to the search system associated with the target model in response to satisfaction of a given condition.

6. The search control system according to claim 3,
wherein the plurality of the language models are associated with search systems having search targets different from one another,
wherein the outputting the search query to the search system includes outputting the search query to a search system associated with the target model in response to satisfaction of a given condition, and
wherein the outputting the search result to the terminal includes outputting, to the terminal, a search result which is received from the search system in response to the output of the search query to the search system and which is obtained for a search target of the search system.

7. The search control system according to claim 3, wherein all of the plurality of the language models are allowed to refer to the log.

8. The search control system according to claim 3, wherein all of the plurality of the language models are set in advance to generate an answer in a common communication style.

9. The search control system according to claim 1,
wherein the operations further comprise repeatedly executing processing of determining, based on the log, a target template out of a plurality of templates, and
wherein the outputting the prompt to the language model includes outputting, to the language model, a prompt based on a chat message received from the terminal and on the target template at a time of receiving the chat message.

10. The search control system according to claim 9, wherein the processing of determining the target template is processing of determining the target template each time a chat message is received from the terminal.

11. The search control system according to claim 9,
wherein each of the plurality of templates is any one of a template associated with a search system or a template unassociated with a search system, and
wherein the outputting the search query to the search system includes outputting, in a situation in which the target template is a template associated with a search system, the search query to the search system associated with the target template in response to satisfaction of a given condition.

12. The search control system according to claim 9,
wherein the plurality of templates are associated with search systems having search targets different from one another,
wherein the outputting the search query to the search system includes outputting the search query to a search system associated with the target template in response to satisfaction of a given condition, and
wherein the outputting the search result to the terminal includes outputting, to the terminal, a search result which is received from the search system in response to the output of the search query to the search system and which is obtained for a search target of the search system.

13. The search control system according to claim 1,
wherein the outputting the chat message to the terminal includes outputting a predetermined chat message indicating that a search is executable in response to satisfaction of a given condition, and
wherein the outputting the search query to the search system includes outputting the search query to the search system in response to reception of a search request in response to the output of the predetermined chat message.

14. The search control system according to claim 13, wherein the outputting the search query to the search system includes outputting the search query to the search system in response to reception of a chat message indicating that a search is requested for the output of the predetermined chat message.

15. The search control system according to claim 1, wherein the log includes a search result in the search.

16. The search control system according to claim 1, wherein the search system is configured to execute a search having, as a search target, one of a product or a service.

17. The search control system according to claim 1, wherein the search query is a keyword to be used for a search for one of a product or a service.

18. The search control system according to claim 1, wherein the search result indicates one of a product or a service.

19. The search control system according to claim 1, further comprising the terminal,
wherein the terminal includes a display configured to display a screen on which chat messages and the search results are arranged in chronological order.

20. A search control method, comprising:
generating, based on a chat message received from a terminal, a prompt to be output to a language model;
outputting the prompt to the language model;
outputting, to the terminal, a chat message based on an answer from the language model to the prompt;
generating a search query based on a log related to exchange of a chat message with the terminal;
outputting the search query to a search system; and
outputting, to the terminal, a search result of a search received from the search system in response to the output of the search query to the search system.

21. A non-transitory computer readable information storage medium storing a program that causes a computer to execute:
generating, based on a chat message received from a terminal, a prompt to be output to a language model;
outputting the prompt to the language model;
outputting, to the terminal, a chat message based on an answer from the language model to the prompt;
generating a search query based on a log related to exchange of a chat message with the terminal;
outputting the search query to a search system; and
outputting, to the terminal, a search result of a search received from the search system in response to the output of the search query to the search system.
